(19) United States
(12) Patent Application Publication
(10) Pub. No.: US 2011/0017070 A1
(43) Pub. Date: Jan. 27, 2011

(54) MODEL OF VESSEL INSTALLATION AND PLACEMENT

(75) Inventor: XINZONG QIN, Foshan (CN)

Correspondence Address: G. LINK CO., LTD., 3550 BELL ROAD, MINOOKA, IL, 60447, US

(73) Assignee: Foshan Green Yinglu Electronic Technology Co., Ltd., Foshan (CN)

(21) Appl. No.: 12/508,788

(22) Filed: Jul. 24, 2009

(51) Int. Cl. B01D 53/14; B03C 1/32; A47B 73/00; A47G 29/00

(52) U.S. Cl. 96/154; 211/74; 211/71.01

(57) ABSTRACT

A model of vessel installation and placement includes a shelf and a vessel installed under the shelf. There is at least one absorbing board equipped respectively on the shelf and arranged alternately. Absorbed boards attached to the absorbing boards are equipped to the bottom or the open of the vessel. Absorbing boards are equipped alternately to the shelf. And absorbed boards are equipped to the bottom or the open of the vessel and are attached to absorbing boards. Hence, when in use, absorbing boards on the shelf are attached to absorbed boards at the bottom or the open of the vessel, which enables that the bottom of the vessel faces up and the open of the vessel points down and is set under the shelf. This method can avoid accumulation of dust and moisture when the vessel is unused for a period of time and can keep clean of the internal vessel, so as to avoid that support frame or internal vessel is accumulated with moisture and dust and keep the vessel clean.

### BACKGROUND OF THE INVENTION

1. Field of the Invention

The invention relates to a model of vessel installation and placement.

2. Description of the Related Art

Please refer to FIG. 1. Generally, the existing vessel placement method is to place open of the vessel upward and bottom of the vessel on the shelf. After a period of time, the vessel placed by this method will accumulate a lot of moisture and dust. In addition, it occupies a large space, and vessel can not be placed under the shelf. In order to solve and avoid the technical problem that moisture and dust are accumulated in the vessel, a kind of vessel upending method is put forward as shown in FIG. 1. The vessel upending method includes the support frame 5, the shelf installed at the bottom of the shelf 6, and the vessel 6 installed on the upper side of the support frame 5. Internal part of the mentioned vessel 7 is suspended on the upper side of the support frame 5. This upending method can avoid accumulation of plenty of moisture and dust in the vessel 7, while after storing for a long time, the support frame 5 and the vessel 7 will also accumulate a few moisture and dust.

### SUMMARY OF THE INVENTION

An object of the invention aims to solve the above mentioned technical problem and provide a model of vessel installation and placement which can avoid thoroughly accumulation of moisture and dust in the vessel after storage for a period of time.

In order to realize the above mentioned object, the invention provides a model of vessel installation and placement. It includes a shelf and a vessel installed on the shelf and is featured in: at least one absorbing board is equipped respectively on the shelf and arranged alternately, and the absorbed board attached to the absorbing board is equipped to the bottom or the open of the vessel.

According to the above mentioned characteristics, the absorbing boards and absorbed boards are composed by opposite poles of magnet or material which is attracted by magnet.

According to the above mentioned characteristics, the shelf is made of plastic or metal.

According to the above mentioned characteristics, section of the shelf is composed by horizontal boards and short vertical boards which are formed integrally with horizontal boards. The horizontal board has some storage troughs with certain interval. The shelf between storage troughs is equipped with absorbing boards.

According to the above mentioned characteristics, the vessel may include cups, bottles and jars.

According to the above mentioned characteristics, the vessel can be placed on and under the shelf.

Beneficial technical effects of the invention: There is at least one absorbing board equipped respectively on the shelf and arranged alternately. An absorbed board attached to the absorbing board is equipped to the bottom or the open of the vessel. Absorbing boards are equipped alternately to the shelf. And the absorbed boards are equipped to the bottom or the open of the vessel and attached to absorbing boards. Hence, when in use, absorbing boards on the shelf are attached to absorbed boards at the bottom or the open of the vessel, which enables that the bottom of the vessel faces up and the open of the vessel points down and is set under the shelf. This method can avoid accumulation of dust and moisture after the vessel is unused for a period of time and can keep the internal vessel clean, so as to avoid that support frame or internal vessel is accumulated with moisture and dust and keep the vessel clean.

In order to have a further understanding on the aim, structural characteristics and functions of the present invention, the following figures are provided for detailed explanation:

### BRIEF DESCRIPTION OF THE DRAWINGS

FIG. 1 is structural diagram of installation and placement with the existing technology;

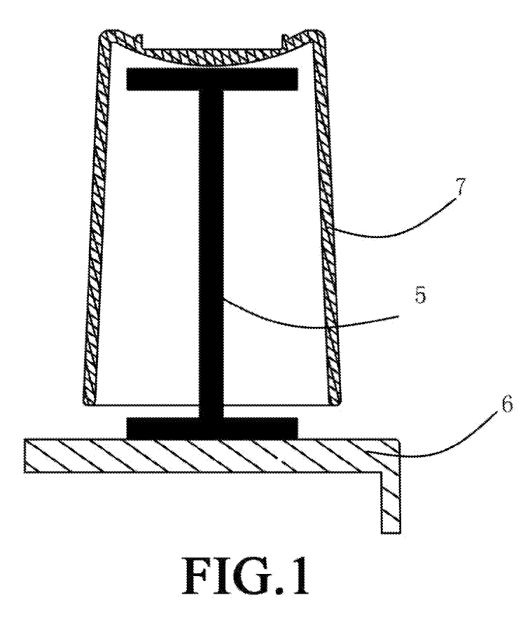

FIG. 2 is structural diagram of installation and placement with this new utility model;

FIG. 3 is the sectional diagram of FIG. 2 A-A; and

FIG. 4 is the sectional amplification diagram of FIG. 3 B-B.

### DETAILED DESCRIPTION OF THE PREFERRED EMBODIMENTS

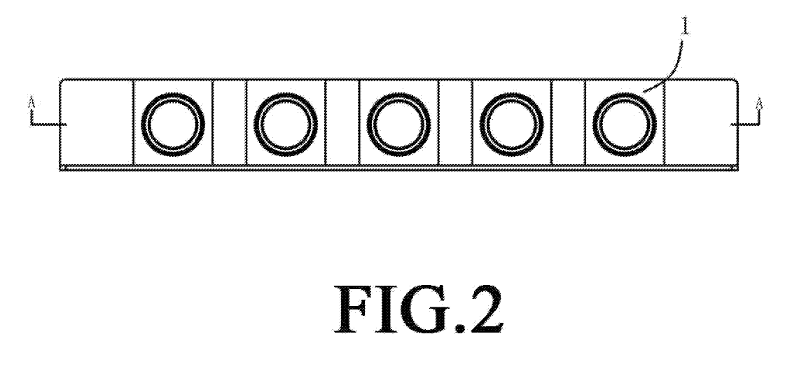

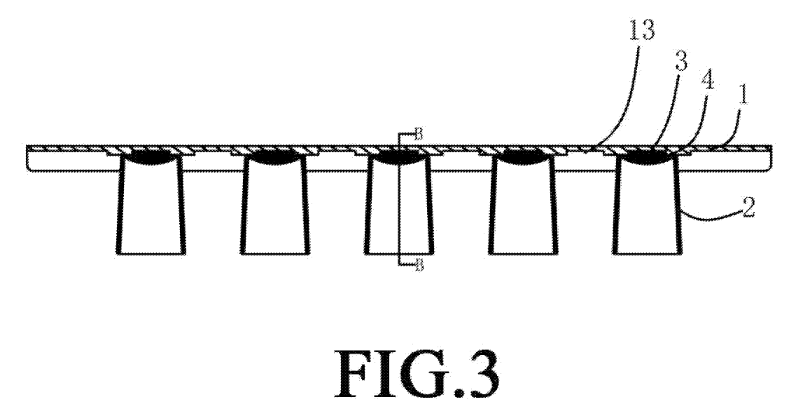

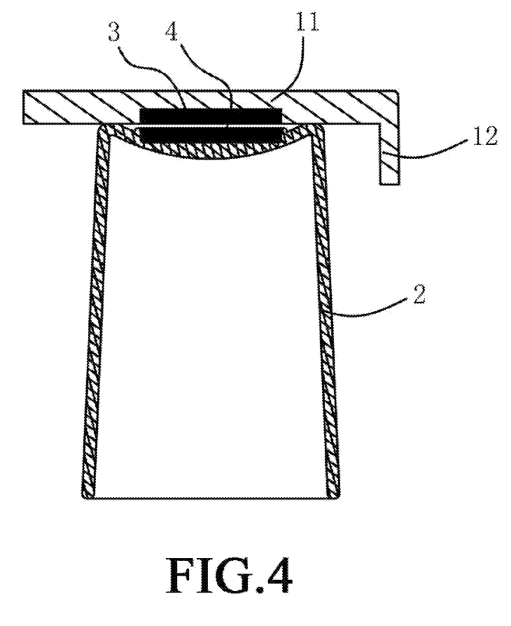

Please refer to FIG. 2, FIG. 3 and FIG. 4. The following application example is used to explain a model of vessel installation and placement provided by this new utility model. It includes shelf 1, vessel 2, absorbing board 3 and absorbed board 4.

The above mentioned shelf 1 is a strip plate. Section of the mentioned shelf is composed by horizontal boards and short vertical boards which are formed integrally with horizontal boards. The horizontal board 11 has some storage troughs 13 with certain interval. The shelf between storage troughs 13 is equipped with absorbing boards 3. The above mentioned shelf 1 is made of plastic or metal. Absorbing boards 3 are arranged alternately on the shelf 1.

In this application example, the above mentioned vessel 2 can be cups, bottles and jars. The mentioned absorbing boards 3 and absorbed boards 4 are composed by opposite poles of magnet or material which is attracted by magnet. The above mentioned vessel 2 can be placed on and under the shelf 1.

During installation, the absorbed board 4 in the bottom or open of the mentioned vessel 2 is attracted by absorbing board 3 set in the shelf 1.

In this application example, the installation and placement model is to install a magnet or material which can be attracted by magnet at the bottom of the vessel 2, and to install one in the shelf 1. Depending on attraction of the magnet, the magnet at the bottom of the vessel 2 is fixed under the shelf 1, so as to enable open of the vessel 2 to face downward, and bottom of the vessel 2 to face upward. Or with the attraction of the magnet, magnet of the open of the vessel 2 is fixed under the shelf 1, so as to enable open of the vessel 2 to face upward and bottom of the vessel 2 to face downward. Material of the shelf 1 can be plastic or metal. There is one or two magnet within the position where the vessel is installed on the shelf 1. (The magnet can also be replaced by material which can be attracted by magnet. This installation method is to place the article on both sides of the shelf 1. When the open faces downward, it can avoid accumulation of dust and moisture effectively and keep the internal vessel clean.

To sum up, there is at least one absorbing board 3 equipped respectively on the shelf I and arranged alternately. The absorbed board 4 attached to the absorbing board 3 is equipped to the bottom or the open of the vessel 2. When in use, absorbing boards 3 on the shelf 1 are attached to absorbed boards 4 at the bottom or the open of the vessel 2, which enables that the bottom of the vessel 2 faces up and the open of the vessel 2 points down and is set under the shelf. This method can avoid accumulation of dust and moisture after the vessel is unused for a period of time and can keep the internal vessel clean, so as to avoid that support frame or internal surface of the vessel 2 is accumulated with moisture and dust and keep the vessel clean.

What is claimed is:

1. A model of vessel installation and placement, composed by a shelf and a vessel which is installed on the shelf, and featured in: at least one absorbing board is equipped respectively on the shelf and arranged alternately, and the absorbed board attached to the absorbing board is equipped to the bottom or the open of the vessel.

2. The model of vessel installation and placement as defined in claim 1, wherein, the above mentioned absorbing boards and absorbed boards are composed by opposite poles of magnet or material which is attracted by magnet.

3. The model of vessel installation and placement as defined in claim 1, wherein the above mentioned shelf is made of plastic or metal.

4. The model of vessel installation and placement as defined in claim 1, wherein section of the above mentioned shelf is composed by horizontal boards and short vertical boards which are formed integrally with horizontal boards. The horizontal board has some storage troughs with certain interval. The shelf between storage troughs is equipped with absorbing boards.

5. The model of vessel installation and placement as defined in claim 1, wherein the mentioned vessel may include cups, bottles and jars.

6. The model of vessel installation and placement as defined in claim 1, wherein the mentioned vessel can be placed on and under the shelf.
